(19) United States
(12) Patent Application Publication
(10) Pub. No.: US 2008/0273044 A1
(43) Pub. Date: Nov. 6, 2008

(54) SEMICONDUCTOR LIGHT-EMITTING DEVICE ILLUMINATED PROJECTION DISPLAY WITH HIGH GRAYSCALE RESOLUTION

(76) Inventors: SERGEI V. GOVORKOV, Los Altos, CA (US); Luis A. Spinelli, Sunnyvale, CA (US)

Correspondence Address: STALLMAN & POLLOCK LLP, 353 SACRAMENTO STREET, SUITE 2200, SAN FRANCISCO, CA, 94111, US

(21) Appl. No.: 12/113,589

(22) Filed: May 1, 2008

Related U.S. Application Data
(60) Provisional application No. 60/927,226, filed on May 2, 2007.

(51) Int. Cl. G09G 5/02

(52) U.S. Cl. 345/599

(57) ABSTRACT

A video display includes a semiconductor light-source, a pixilated spatial light modulator (SLM) for spatially modulating light from the light source and projection optics for projecting spatially modulated light from the spatial light modulator onto the screen to form the video. A desired relative brightness contribution in the display of a pixel element of the SLM is achieved by varying the power output of the light-source over a refresh-period and switching the pixel element to an on-state for a predetermined portion of the refresh-period.

### PRIORITY CLAIM

This application claims priority of U.S. Provisional Patent Application No. 60/927,226, filed May 2, 2007, the complete disclosure of which is hereby incorporated by reference.

### TECHNICAL FIELD OF THE INVENTION

The present invention relates in general to projection video displays including a spatial light modulator (SLM). The invention relates in particular to such video displays in which the SLM is illuminated by a semiconductor light-emitting device such as an edge-emitting semiconductor laser, a surface-emitting semiconductor laser, or a light-emitting diode (LED).

### DISCUSSION OF BACKGROUND ART

Several commercially important types of projection displays utilize pixilated modulators based on micro-mechanical devices, generally falling into a category of modulators collectively known as spatial light modulators. Some of these modulators operate digitally, in a sense that each pixel can fully transmit, reflect, or diffract (depending on the modulator type) or block light entirely. One example of such a modulator is a DLP® modulator available from Texas instruments Inc., of Dallas, Tex. This is a two-dimensional SLM in which each pixel element is a movable mirror. Using such a modulator, half tones or gray levels are produced by pulse-width modulating (PWM) the mirrors (pixels) over the operating refresh-period of a display. In this case, the refresh-period is the frame-period per color of the display. Input video signals are converted to the PWM format by supporting electronics.

A detailed description of this PWM technique is presented in a paper Emerging Digital Micromirror Device (DMD) Applications, Dudley et al., SPIE Proceedings Vol. 4985, Copyright 2003 Society of Photo-Optical Instrumentation Engineers. A summary of the teaching of this reference is set forth below including data extracted therefrom.

FIG. 1 schematically illustrates a binary PWM pixel representation, with 5 bits-per-color resolution. Bit lengths are 1, 2, 4, 8, and 16 units long (see line A of FIG. 1) where a unit is 1/(2^{N}−1) of the total refresh-period. In the 5-bit color of this example the lowest intensity level per color is constructed by turning the pixel on for 1/(2^{N}−1) of the total refresh-period, where N is the number of bits per color. In this example, 1/(2^{N}−1) is 1/31.

Higher intensities are formed by increasing “on” time, but the smallest grayscale increment is limited by the bit resolution. Maximum intensity is achieved by a pixel being “on” throughout a refresh-period. The human visual system effectively integrates the pulsed light such that the duration of the pulsed light determines the perception of desired intensity. The gray scale perceived is proportional to the percentage of time the mirror is “on” during the refresh-period. Lines B and C of FIG. 1 schematically illustrate formation of intensities respectively 48% and 84% of maximum by binary PWM signals 01111 and 11010 respectively.

The maximum number of bits possible per refresh-period is limited by the switching time of an individual pixel. By way of example, FIG. 2 schematically illustrates “switching” of a micro-mirror commanded to change from one binary state to another (bold curve) and commanded to remain in the same state (fine curve). It can be seen that after the mirror has been commanded either to change state or remain in the same state, there is a period during which the mirror undergoes damped oscillation before stabilizing in the required state, in which stabilized state the switching cycle can be considered complete. Here, this complete switching cycle requires at least 18 microseconds (μs). This switching time provides that there is a trade-off relationship between the maximum number of bits per frame, and the frame rate. This relationship is schematically illustrated in FIG. 3.

For high quality video reproduction, it is desirable to have high frame-rate, and high grayscale resolution at the same time. Reducing switching time of spatial light modulators is a challenging task, which may or may not be successfully accomplished. There is a need for a method for providing higher grayscale resolution with relying on improvements in the switching time of spatial light modulators.

### SUMMARY OF THE INVENTION

The present invention is directed to expanding grayscale resolution in video display apparatus. In one aspect apparatus in accordance with the present invention comprises a light-source and a spatial light modulator arranged to spatially modulate light from the light-source. The spatial light modulator includes a plurality of pixel elements, the pixel elements being individually switchable between off and on states. The apparatus includes projection optics for projecting spatially modulated light from the spatial light modulator onto a screen to form a video display. Power output of the light-source is varied over a refresh-period of the display as a predetermined function of time and a pixel element of the spatial light modulator is switched to the on-state for a predetermined portion of the refresh-period to provide a desired relative brightness contribution of that pixel element in the projected video display.

In a preferred embodiment of the apparatus, the light source is semiconductor light-emitting device such as a laser-diode. Such a device is essentially responsive to changes in drive current. This provides flexibility in selecting a power-output versus time function for the light-source.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain principles of the present invention.

FIG. 1 schematically illustrates a prior-art pulse-with modulation technique for providing different perceived light-intensities in a display based on a constantly illuminated spatial light modulator.

FIG. 2 is a graph schematically illustrating switching time of a modulator pixel in a micro mirror modulator suitable for executing the technique of FIG. 1.

FIG. 3 is a graph schematically illustrating a trade-off between the maximum number of bits refresh-period and modulator switching time in the technique of FIG. 1

FIG. 4 schematically illustrates, in block-diagram form, one example of a semiconductor light-emitting device illuminated display in accordance with the present invention, wherein the output-power of the light-emitting device is varied as a predetermined function of time during a refresh-period in combination with application of pulse-width-modulation.

FIGS. 5A-C collectively form a timing diagram schematically illustrating the combination of pulse-width modulation and light-emitting device power output variation in the display of FIG. 4.

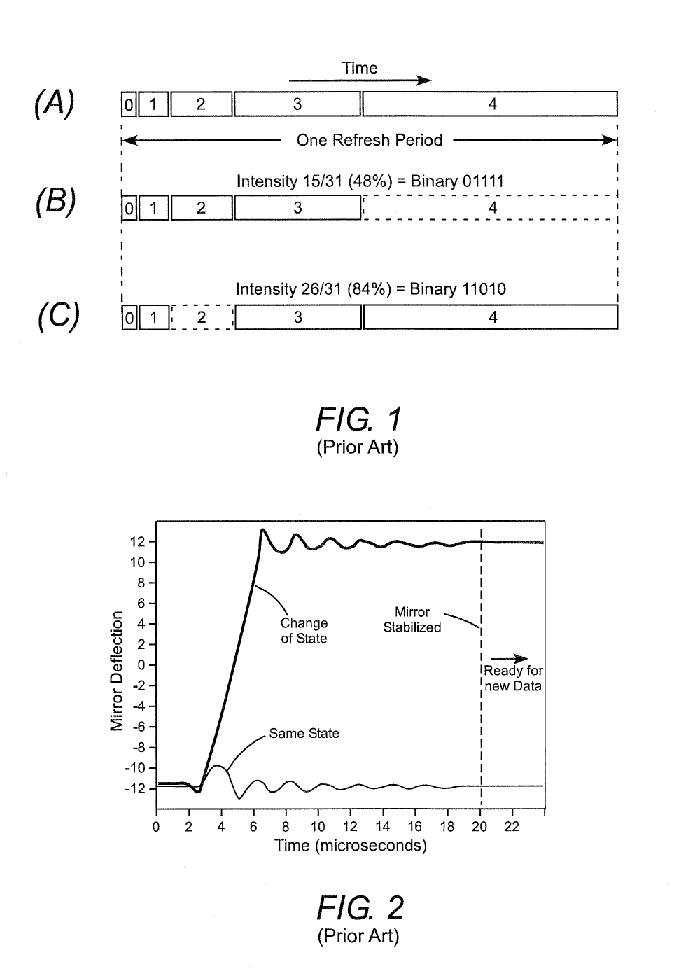

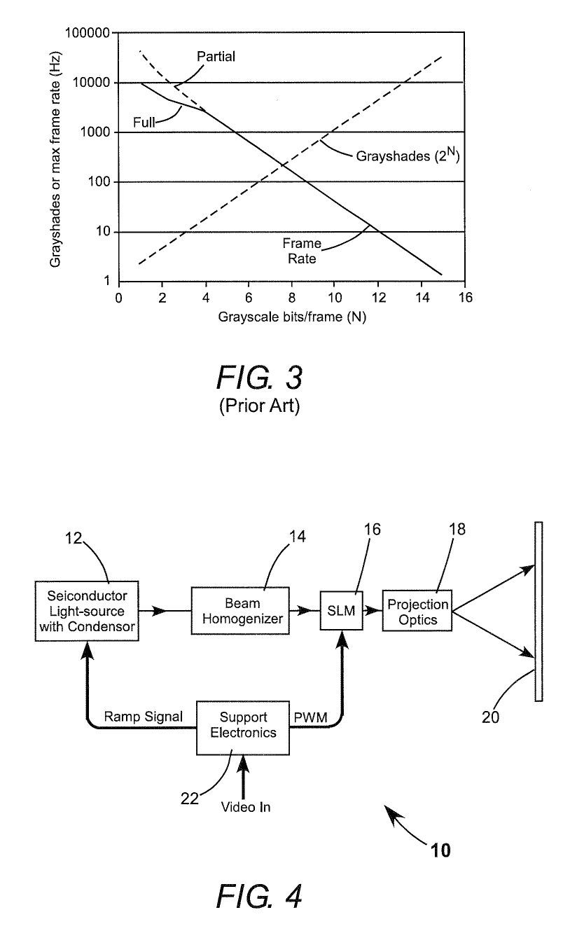

### DETAILED DESCRIPTION OF THE INVENTION

Referring now to the drawings, FIG. 4 schematically illustrates a preferred embodiment 10 of a projection display in accordance with the present invention. Display 10 includes a semiconductor light-emitting device (semiconductor light-source) 12. Such a source may include a light-emitting diode, an edge-emitting semiconductor (diode-laser), or an electrically pumped vertical cavity surface-emitting semiconductor laser. The light-source may also include an optically pumped (diode-pumped) semiconductor laser (OPS-laser) wherein optical pumping is provided by a diode-laser or an array thereof. These light-sources can be essentially instantly intensity-modulated in almost any arbitrary pattern by modulating the supply current to the sources (or modulating current to the optical pumping source in the case of an OPS-laser). This is due to the fact that excited states in a semiconductor device have a very short storage time (excited-state lifetime), which provides that light-output from the source responds to the current variation essentially instantly. Additionally, the light-output is a linear function of current in a broad operating range.

Information about OPS lasers can be found in the following commonly owned U.S. patents, each of which is incorporated herein by reference: U.S. Pat. Nos. 6,438,153 and 6,940,880.

Display 14 includes a beam homogenizer for homogenizing the spatial distribution of light delivered from source 12. Source 12 includes an optical condenser arrangement for directing the light into the homogenizer. Light-output from the homogenizer illuminates an SLM 16, and projection optics 18 project light modulated by the SLM onto a screen 20 for display. A detailed description of optical arrangements of display 10 is not necessary for understanding principles of the present invention and accordingly is not presented herein. A detailed description of a semiconductor light-emitting device illuminated display including an SLM is provided in U.S. Pat. No. 7,244,028, assigned to the assignee of the present invention, and the complete disclosure of which is hereby incorporated by reference.

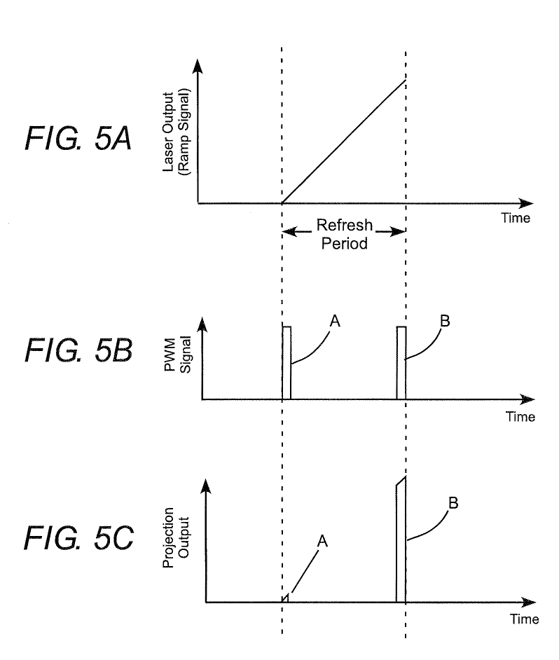

An important aspect in which the inventive display 10 differs from prior-art displays, in which intensity levels are determined by PWM alone, is that PWM is combined with modulation of the output of light-source 12 as a predetermined function of time during a refresh-period. Video input for projection is received by support electronics 22. Electronics 22 supplies a PWM signal specifying a particular pulse-width for a given pixel and provides an output power ramp-signal function to light-source 12. The perceived intensity of the pixel output depends on the pulse-width specified and the time during the refresh-period during which that pulse width occurs. This provides that higher grayscale resolution is available for a given number of bits than is available using PWM alone. A simple example is graphically schematically illustrated in FIGS. 5A-C.

FIG. 5A graphically depicts output of light-source 12 of FIG. 4 modulated as a linear function from zero to some maximum value over a refresh-period of display 10. In a system with a single two-dimensional SLM, the system cycles through the three primary colors, red green and blue (RGB). The refresh-period discussed in this case represents the refresh-period of one primary color. The actual frame rate of the RGB display would be the reciprocal of three times the refresh-period. It is also possible to have separate R, G, and B light-sources with separate R, G, and B SLMs projecting simultaneously, in which case the refresh-period would be equal to the frame-period. In a line-scan system using a one-dimensional SLM a refresh-period would be the time required to project one line of the display.

FIGS. 5B and 5C graphically depict a single bit (least significant bit (LSB)) PWM waveform representing two levels of gray. Each has the same width, however, one (pulse A) corresponds to a lowest value of 0.02 of the maximum possible and the other (pulse B) to 0.19 of the maximum possible, here, assuming a pulse duration of 0.1 of a refresh period. The combination of the pulse width and the output-power variation is depicted in FIG. 5C wherein it can be seen that the projected output intensity, and accordingly the gray level, is dependent on the temporal position of a pulse within the refresh-period. In this example, the increment between intensity levels caused by shifting the pulse by 0.1 of a refresh-period is 0.01 of the maximum output. In a prior-art, PWM-only, arrangement the projected output is independent of the position of a pulse in a refresh-period.

One possible drawback of the inventive light-source modulation scheme is that the output of the light-source is effectively reduced by the modulation, correspondingly reducing the brightness of the display. In the case of linear ramp as depicted in FIG. 5A, the average output is only one-half of the peak output. In most semiconductor light-sources, however, the maximum constant output power of the light-source is usually limited by the average amount of heat that needs to be dissipated per unit time. Accordingly, as the refresh-period is relatively short in thermal terms, the peak output power can be adjusted to maintain the average output-power at a level comparable with constant operation.

If this cannot be done due to limitations of the peak power, it would be possible to provide that the ramp function reached a maximum in less than a refresh-period and stayed constant for the remainder of the period. This would achieve higher brightness at the expense of reduction in grayscale resolution, but still provide greater resolution than would possible with a comparable prior-art PWM-only arrangement. Those skilled in the art may use other non-linear modulation functions for the light-source, smoothly variable or with portions thereof constant during a refresh-period, without departing from the spirit and scope of the present invention. In one example, the laser can be energized to full output power at the beginning of the refresh period at terminated a predetermined time thereafter within the refresh period. By controlling the termination point, an almost limitless variation in available grey scale can be achieved.

In summary, the present invention is described above in terms of a preferred and other embodiments. The invention, however, is not limited to the embodiments described and depicted. Rather the invention is limited only by the claims appended hereto.

What is claimed is:

1. Video display apparatus, comprising:
a light-source;
a spatial light modulator arranged to spatially modulate light from the light-source, the spatial light modulator including a plurality of pixel elements, the pixel elements being individually switchable between off and on states;
a screen;
projection optics for projecting spatially modulated light from the spatial light modulator onto the screen to form a video display; and
wherein the power output of the light-source is varied over a refresh-period of the display as a predetermined function of time, and wherein a pixel element of the spatial light modulator is switched to the on-state for a predetermined portion of the refresh-period to provide a desired relative brightness contribution of that pixel element in the video display.

2. The apparatus of claim 1, wherein the light-source is a semiconductor light-emitting device.

3. The apparatus of claim 2, wherein the semiconductor light-emitting device is one of an edge-emitting semiconductor laser, a surface-emitting semiconductor laser, and a light-emitting diode.

4. The apparatus of claim 3, wherein the power-output of the light-source is varied by varying an electric current-energizing the light-emitting device.

5. The apparatus of claim 3, wherein the semiconductor light-emitting device is an optically-pumped semiconductor laser.

6. The apparatus of claim 1, wherein pixel-elements of the spatial light modulator are in a two-dimensional array thereof and the refresh-period is a frame-period of the video display.

7. The apparatus of claim 1, wherein the power output of the light-source is varied linearly as a function of time during the refresh-period.

8. The apparatus of 7, wherein the power output of the light-source is varied from about zero at a beginning of the refresh-period to a maximum value at an end of the refresh-period.

9. Video display apparatus, comprising:
a semiconductor light-emitting device;
a spatial light modulator arranged to spatially modulate light from the light-emitting device, the spatial light modulator including a plurality of pixel elements, the pixel elements being individually switchable between off and on states;
a screen;
projection optics for projecting spatially modulated light from the spatial light modulator onto the screen to form a video display; and
control electronics for controlling the light-emitting device and the spatial light modulator,
the control electronics being arranged to vary the output power of the light-emitting device over a refresh-period of the display as a predetermined function of time, and to switch a pixel element of the spatial light modulator to the on-state for a predetermined portion of the refresh-period to provide a desired relative brightness contribution of that pixel element in the video display.

10. The apparatus of claim 9, wherein the semiconductor light-emitting device is one of a light-emitting diode, an edge-emitting semiconductor laser, a surface-emitting semiconductor laser, and an optically pumped semiconductor laser.

11. The apparatus of claim 3, wherein the power-output of the light-emitting device is varied by varying an electric current-energizing the light-emitting device.

12. A projection system comprising:
a semiconductor based light source generating an intensity controllable light output in response to a variable input current;
a spatial modulator receiving the light output from the light source, said spatial light modulator including movable mirrors for time modulating the reflection of the light from the source;
a screen receiving the light output after modulation by the light modulator; and
a controller coupled to the light source and the spatial light modulator for controlling the intensity of the light output of the light source as well as the switching periods of the movable mirrors to thereby provide control of the intensity of the light output received by the screen.

13. A system as recited in claim 12, wherein the intensity of the light output from the light source is varied by varying in input current.
